(19) United States
(12) Patent Application Publication
(10) Pub. No.: US 2026/0078058 A1
(43) Pub. Date: Mar. 19, 2026

(54) UNDERLAYMENT MATERIAL COMPOSITION AND METHODS OF PREPARING AND APPLYING THE SAME

(71) Applicant: ONX, INC., Georgetown, TX (US)

(72) Inventor: Mohamed Kassim Jahaber, Dubai (AE)

(21) Appl. No.: 18/886,626

(22) Filed: Sep. 16, 2024

(51) Int. Cl. C04B 28/14; C04B 11/26; C04B 16/02; C04B 103/20; C04B 103/32; C04B 111/10; C04B 111/60

(52) U.S. Cl. CPC C04B 28/146; C04B 11/26; C04B 16/02; C04B 2103/20; C04B 2103/32; C04B 2111/1037; C04B 2111/60; C04B 2201/20; C04B 2201/30; C04B 2201/50

(57) ABSTRACT

An underlayment material composition is disclosed that includes a binder, a filler, a polymer, and a retarder. The binder includes calcium sulphate alpha hemihydrate, the filler includes cork, the polymer includes superplasticizer, and the retarder includes modified amino acid. The underlayment material exhibits a thermal resistance value that exceeds a threshold value for a defined thickness value. Further, a method of using the underlayment material composition in non-structural applications of one or more construction-related activities includes mixing the underlayment material composition, that includes the binder, the filler, the polymer, and the retarder, with a defined amount of water for a defined amount of time to produce an underlayment material composition mix having a defined consistency. The method further includes applying a coat of the underlayment material composition mix on a primer-coated surface.

### FIELD OF THE INVENTION

The present disclosure generally relates to underlayment material compositions formulated for non-structural applications as well as methods of using such compositions in construction-related activities. In particular, the present disclosure relates to non-structural self-levelling composite that when hydrated produces an underlayment material composition having high compressive strength, fast setting, high thermal resistance, and is able to withstand heavy load without chipping, powdering, and/or cracking.

### BACKGROUND OF THE INVENTION

Builders of both commercial and non-commercial buildings are constantly looking for new innovative products in order to make buildings more environmentally friendly and energy efficient, to better protect them from the weather, and to make them more aesthetically pleasing, among other like objects.

In recent times, impacts of various phenomena, such as global warming and lower ozone formation, have had substantial negative impacts on the environment. Various nations across the world have drafted plans on how to address such impacts. One major factor that exacerbates such impacts has been the usage of cement-based products, such as underlayment material, for the development of cities across the world. Moreover, technological advancements have resulted in cement-making companies producing higher volumes of cement-based products compared to the past, thereby increasing environmental harm at various stages of the development process.

### SUMMARY OF THE INVENTION

Embodiments of underlayment material compositions and methods for manufacturing and using them in non-structural applications to address at least some of the above challenges and issues are disclosed.

In some aspects, the present disclosure is directed to an underlayment material composition. The underlayment material composition includes a binder, a filler, a polymer, and a retarder. The binder includes calcium sulfate alpha hemihydrate (CSαH), the filler includes cork, the polymer includes a superplasticizer, and the retarder includes modified amino acid. The underlayment material exhibits a thermal resistance value that exceeds a threshold value for a defined thickness value.

In some embodiments, a defined amount of water is added to the underlayment material composition such that a homogeneous mixture is formed with a consistency within a predetermined range.

In some embodiments, the underlayment material composition forms a cement-free composite material.

In some embodiments, the underlayment material composition forms a non-structural self-levelling composite material.

In some embodiments, the underlayment material composition forms a curing-free composite material.

In some embodiments, a coat of the underlayment material composition is applied on different types of subfloors.

In some embodiments, a coat of the underlayment material composition is compatible with different types of floor coverings.

In some embodiments, a quantity of the calcium sulphate alpha hemihydrate is between 49-51% of the underlayment material composition by volume, a quantity of the cork is between 48-49% of the underlayment material composition by volume, a quantity of the superplasticizer is between 1-2% of the underlayment material composition by volume, and a quantity of the modified amino acid is between 0.1-0.01% of the underlayment material composition by volume.

In some embodiments, properties of the underlayment material composition comprise one or more of: a compressive strength of at least 3500 PSI, a dry density of 115 lbs/ft³, a thermal resistance of R 0.8 at 25 mm thickness, and a specific heat of 229 BTU at 85° F.

In some aspects, the present disclosure is directed to a method of using underlayment material composition in one or more construction-related activities. The method includes preparing the underlayment material composition having a binder comprising calcium sulphate alpha hemihydrate, a filler comprising cork, a polymer comprising superplasticizer, and a retarder comprising modified amino acid. The method further includes mixing the underlayment material composition with a defined amount of water for a defined amount of time to produce an underlayment material composition mix having a defined consistency. The method further includes applying a coat of the underlayment material composition mix on a primer-coated surface. The underlayment material composition mix exhibits a thermal resistance value that exceeds a threshold value for a defined thickness value.

In some embodiments, the defined consistency corresponds to a homogeneous mixture of flowable workability.

In some embodiments, the coat of the underlayment material composition mix is applied on different types of subfloors.

In some embodiments, the coat of the underlayment material composition mix is compatible with different types of floor coverings.

In some aspects, the present disclosure is directed to a method of preparing an underlayment material composition mix. The method includes preparing an underlayment material composition having a binder comprising calcium sulphate alpha hemihydrate, a filler comprising cork, a polymer comprising superplasticizer; and a retarder comprising modified amino acid. The method further includes mixing the underlayment material composition with a defined amount of water for a defined amount of time to produce an underlayment material composition mix having a defined consistency. The underlayment material composition mix exhibits a thermal resistance value that exceeds a threshold value for a defined thickness value.

In some embodiments, a quantity of the calcium sulphate alpha hemihydrate is between 49-51% of the underlayment material composition by volume, a quantity of the cork is between 48-49% of the underlayment material composition by volume, a quantity of the superplasticizer is between 1-2% of the underlayment material composition by volume, and a quantity of the modified amino acid is between 0.1-0.01% of the underlayment material composition by volume.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates ingredients collated in the form of a group that make up an exemplary underlayment material composition, in accordance with some embodiments of the present disclosure.

FIG. 2 illustrates an arrangement for manufacturing underlayment material compositions, in accordance with some embodiments of the present disclosure.

FIG. 3 illustrates the steps of a method for preparing and using underlayment material compositions for non-structural applications, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown but is to be accorded the widest possible scope consistent with the principles and features disclosed herein.

Carbon dioxide emissions are recognized as a significant concern relating to cement production and the use of cement-based products and concrete as a building material. With modernization in construction-related methodologies and technologies, there has been a rapid shift from producing cement in large quantities to identifying innovative construction approaches that reduce the volume of cement products and their corresponding emissions.

The construction industry has been on the look-out for better, stronger, and more sustainable non-structural products, such as underlayment material. Innovative approaches are sought that can be part of an underlayment material composition strategy. Such innovative approaches should aim at providing sustainable environmental-friendly (e.g., substantially, or entirely free of cement) products as a non-structural material.

Further, innovative approaches should aim at providing advantages such as, but not limited to, reducing carbon emissions, reducing the use of natural resources for making concrete, reducing the use of water materials in concrete, and reducing air, land, and water pollution. The embodiments of the present disclosure aim to provide an improved, new, underlayment material composition having several advantages, some of which are listed above.

Embodiments of the present solution provide new, improved, and ecofriendly underlayment material compositions, with many advantages, such as high compressive strength and high thermal resistance, in non-structural applications. By leveraging such underlayment material compositions in building architectures, the present disclosure ensures remarkable properties, such as durability, fire resistance, self-levelling property, fast setting time, elimination, or reduction of shrinkage cracks, powdering and chipping, no curing, and high thermal resistance.

Therefore, new, and improved underlayment material compositions are needed for use in construction-related activities, especially for non-structural applications. The present disclosure provides such compositions as well as methods of making and using such compositions in non-structural applications, such as a floor underlayment.

Underlayment material compositions in accordance with the embodiments are different from conventional underlayment products. Such a difference is based on use as well as composition. In some embodiments, the underlayment material compositions include a specific form of calcium sulfate, such as calcium sulfate alpha hemihydrate, and do not include cement. Further, the underlayment material compositions include cork, retarders (such as modified amino acid), and a polymer comprising superplasticizers (such as specially formulated polycarboxylate powder). Furthermore, the underlayment material compositions find use in non-structural applications requiring high compressive strength and high thermal resistance.

Further, according to some embodiments of the present disclosure, the underlayment material compositions emits 71% lesser carbon dioxide to the atmosphere as compared with cement-based products. For example, the underlayment material compositions emit 240 gr CO₂ eq/kg) whereas conventional-cement-based underlayment products emit 830 gr CO₂ eq/kg. Furthermore, some embodiments reduce the damage to human health and eco-systems by at least 73% and resource damage by 23% as compared to conventional cement-based underlayment products. Furthermore, in some embodiments, the underlayment material compositions reduce the damage to human health and eco-systems by at least 73% as compared to conventional cement-based underlayment products, thereby making the proposed underlayment material compositions environmentally preferable solutions.

Some embodiments provide several other objects and advantages, some of which are discussed below. Underlayment material compositions, in accordance with some embodiments, are in powder form in contrast with the conventional underlayment products in sheet forms. Further, the underlayment material compositions have rapid-setting properties, enabling quick setting with no curing (such as water curing, steam curing, accelerated curing, or air curing), resulting in improved productivity. A further significant advantage provided by the underlayment material compositions is their high thermal resistance. For example, floor coverings made of the underlayment material compositions do not allow significant heat transfer through them. Such installation improves the thermal comfort inside the house by consuming less electricity. In addition, the underlayment material compositions are lighter than conventional concrete of the same grade and do not shrink, among other like benefits. In some embodiments, the dry density of the underlayment material composition is 115 lbs/ft³, which is lighter than conventional product.

Using the underlayment material compositions results in reduced insurance costs due to increased security, high strength, and high fire-resistance as compared to structures manufactured with conventional compositions. These and other like advantages make the disclosed embodiments more environmentally friendly, economical, and sustainable.

Certain terms and phrases have been used throughout the disclosure and will have the following meanings in the context of the ongoing disclosure.

“Cement” for the purposes of the present disclosure refers to a substance that sets and hardens to bind other materials together. Cement is manufactured through a closely controlled chemical combination of calcium, silicon, aluminum, iron, and other ingredients. Common materials used to manufacture cement are able to include, but are not limited to, limestone, shells, and chalk or marl combined with shale, clay, slate, blast furnace slag, silica sand, and iron ore. Some of the types of cement include, but are not limited to, hydraulic and elite cements, such as Portland Cement, blended cement, masonry cement, oil well cement, natural cement, alumina cement, expansive cement, and the like, and mixtures thereof.

“Non-structural materials” for the purposes of the present disclosure refer to materials that are used for the purposes other than supporting loads, but still contribute to performance and functionality of a building structure. As underlayment material does not support any load and is not able to be used to construct load bearing elements, the underlayment material is referred to as a non-structural material.

“Underlayment” for the purposes of the present disclosure refers to a thin layer of material that helps to provide a cushion, improves acoustical performance, protects from moisture, provides additional thermal properties, and reduces wear and tear of a flooring. In some embodiments, an underlayment layer is installed between a subfloor and a floor covering. The underlayment is able to reduce the impact of minor subfloor imperfections, such as small cracks or minor leveling issues, to ensure that the floor covering is installed on an even surface.

“Gypsum” for the purposes of the present disclosure refers to a soft sulfate mineral composed of calcium sulfate dihydrate. Gypsum is widely used as a main constituent in many forms of plaster and drywall. Gypsum is also referred to as plasterboard, sheetrock, or drywall in various construction-related applications.

“Calcium sulfate hemihydrate” for the purposes of the present disclosure refers to a compound that is made from gypsum ore, a naturally occurring mineral (calcium sulfate dihydrate CaSO4·2H2O). After being mined, the raw gypsum is thermally processed to form a settable calcium sulfate, which is anhydrous, and typically is the hemihydrate, CaSO4·½H2O. The settable calcium sulfate reacts with water to solidify by forming the dihydrate (gypsum). The hemihydrate has two recognized morphologies, for example, alpha hemihydrate and beta hemihydrate. Upon hydration, beta hemihydrate is characterized by hydrating to produce needle-shaped crystals of gypsum, typically with large aspect ratio. On the other hand, in accordance with some embodiments of the present disclosure, alpha hemihydrate is characterized by giving rise to rectangular-sided crystals of gypsum.

“Superplasticizer” for the purposes of the present disclosure refers to a type of a chemical admixture used where a well-dispersed particle suspension is required. A superplasticizer refers to a class of plasticizers that has fewer deleterious effects and is used to increase workability more than traditional plasticizers. The addition of a superplasticizer to a mixture allows the reduction of water content, while not affecting the workability of the mixture. Such treatment improves the strength and durability characteristics of the mixture and enables the production of self-consolidating and high-performance composition.

In accordance with some embodiments, the present disclosure is directed to an underlayment material composition for use as a non-structural material. The underlayment material composition is able to include a binder comprising calcium sulfate alpha hemihydrate (CaSO4·½H2O) (CSαH), a filler comprising cork, a polymer comprising superplasticizer, and a retarder comprising modified amino acid. The retarder is able to include at least poly condensed or modified amino acid, and the superplasticizer is able to include specially formulated polycarboxylate powder.

In some embodiments, the underlayment material composition is able to exhibit various properties, such as, but not limited to, a compressive strength of at least 3500 PSI, a dry density of at least 115 lbs/ft³, a thermal resistance of R 0.8 at 25 mm thickness, a specific heat of at least 229 BTU at 85° F., and a Class A1 fire rating or better. It should be noted that in some embodiments, the above values of different parameters are the minimum values. However, in other embodiments, the values are able to exceed by another 5%, without any deviation from the scope of the disclosure.

In some embodiments, the underlayment material composition is available in a prepacked/prepackaged form, where water is added in an amount such that a desired flowable consistency and workability of the underlayment material composition is achieved. Any excessive addition is able to affect the workability of the underlayment material composition. In some embodiments, the workability of the underlayment material composition is able to be assessed by a slump flow parameter. The slump flow parameter is determined based on, for example, a flow table test or a slump-flow test that corresponds to a method to determine consistency of the underlayment material composition before it sets. It is to be noted that the above example should not be construed as limiting, and other methods or techniques can also be utilized to determine the slump flow parameter.

In some embodiments, the underlayment material composition of the present disclosure is highly suitable for one or more of: a commercial project, a residential project, a multifamily project, a radiant heating project, and a renovation project. In some embodiments, the underlayment material composition of the present disclosure is compatible with any type of floor covering including vinyl composition tile, ceramic tile, wood laminate, hardwood, granite, and marble. The underlayment material composition of the present disclosure is able to be applied over any type of subfloor, such as veneer and non-veneer wood floor, a concrete subfloor, and the like.

In some embodiments, the underlayment material composition, so disclosed, is able to be used in one or more non-structural applications. For such embodiments, the underlayment material composition is added to water in a mixer. In some embodiments, the underlayment material composition is blended in the mixer for a predetermined amount of time, such as 3 minutes, at a first speed (a normal speed), where the predetermined amount of time is at least based on a type of the mixer.

In some embodiments, the setting time of the underlayment material composition mix is a time period between approximately 45 to 60 minutes. It will be appreciated that other time periods are contemplated based on the various environmental conditions, such as humidity, temperature, and the like.

These and other embodiments are discussed in detail below.

In some embodiments, the present disclosure relates to an underlayment material composition that includes a binder, a filler, superplasticizer(s), and retarder(s). In some embodiments, the binder includes CSαH, the filler includes cork, the superplasticizer(s) includes specially formulated polycarboxylate powder, and the retarder(s) includes poly condensed or modified amino acid and calcium (Ca) salt. CSαH for the purposes of the present disclosure refers to CaSO4·½H2O. A person of ordinary skill in the art will understand that calcium sulfate is available in many forms such as, but not limited to, calcium sulfate alpha hemihydrate, anhydrous calcium sulfate, etc.

Some underlayment material compositions in accordance with the embodiments include CSαH because of the various advantages. For example, CSαH provides a highest increase in gelation and improved final setting times of the resulting underlayment material composition mix. In some embodiments, alpha-hemihydrate grade of CSαH rises with the compactness, smoothness, and granulation of the crystals on which depends the water requirement controlling mechanical properties of the prepared dihydrate. A hemihydrate composed of smooth, compact, large monocrystals, as described in references, gives a dihydrate of good utilitarian properties.

In some embodiments, the alpha hemihydrate is characterized by giving rise to rectangular-sided crystals of gypsum that have dense microstructures having higher strength and density than those formed by the beta hemihydrate. Further, the alpha-type high-strength gypsum powder is high in hydration speed, beneficial to saving the stripping time, and capable of being produced in a large-scale mode. Additionally, the alpha-type high-strength gypsum powder has various advantages, such as light-weight, good fire prevention, good sound isolating and heat insulating performance, fast solidification, dimensional stabilization, good decorative property, low energy expenditure, best mechanical resistances in a short time, insensitivity to elevated temperatures, to name a few. A person of ordinary skill in the art will understand that CSαH is typically prepared from gypsum, such as, calcium sulfate alpha hemihydrate. Further, in an example, gypsum which is naturally available in solid form as deposits, undergoes many processes, such as (but not limited to) grinding and heating under high pressure to get the final CaSO4·½H2O (CSαH) in fine powder form in factories.

In some embodiments, an underlayment material composition includes CSαH, where the recommended weight of CSαH is between 49-51% of the underlayment material composition. In an example, the quantity of CSαH is approximately 500 kgs by volume. CSαH material acts like a binder and the quality of CSαH directly influences the properties, such as compressive strength, flexural strength, setting time, durability of the resulting mixture. CSαH is able to react with other fundamental components of the underlayment material composition, as mentioned above, to minimize or eliminate shrinkage cracks while imparting other useful properties to the disclosed underlayment material composition. Further, CSαH provides higher compressive strengths as compared to other forms of calcium sulfate. In some embodiments, a blend of two or more forms of calcium sulfate is able to be used to modify the set times and early compressive strength properties as suitable for the non-structural requirements. Early setting time is an intrinsic property of all calcium sulfates and CSαHs. CSαHs typically lose their plasticity within a predefined minutes of being mixed with water. Thus, in some embodiments, CSαH is able to impart longer setting times with the aid of a retarder. The compressive strength of the obtained underlayment material composition is able to be enhanced with CSαH. All CSαHs are available in the market and are of different types and pH values. In some embodiments, two or more CSαHs are blended to obtain the required pH value in a given underlayment material composition.

In some embodiments, the plaster material composition includes filler comprising cork, the filler being an agro-based bio fiber. In some embodiments, the recommended weight of cork is between 48-49% of the underlayment material composition. In an example, the quantity of the cork is approximately 100 kgs by volume. The cork is a natural material that enhances the thermal resistance of the underlayment material composition. Cork's bubble-form structure, low density, and natural fire-retardant feature makes the cork suitable for acoustic and thermal insulation. Cork is a natural material derived from the bark of the cork oak tree. As cork is a lightweight material, it is easy to handle and transport. Cork is an excellent insulator, both thermally and acoustically. Cork helps regulate temperature and is able to reduce noise transmission. When added to the plaster material as a filler, the natural insulating properties of cork are able to enhance the thermal insulation of the plaster material, contributing to better energy efficiency of the flooring. The sound-absorbing characteristics of cork are able to contribute to improved acoustics when added to the plaster material. It should be noted that the present disclosure is not limited to cork, and any other agro-based bio fiber is also able to be used in accordance with the disclosed embodiments.

A polymer comprising superplasticizer is used in some embodiments of the present underlayment material composition. In some embodiments, a recommended quantity of the superplasticizer is between 1-2% of the underlayment material composition. In an example, the quantity of superplasticizer is approximately 5-10 kgs by volume. In some embodiments, a suitable fluidity of the underlayment material composition depends on a type of the plasticizer, a dosage of the plasticizer, or both. In some embodiments, the superplasticizer comprises a specially formulated polycarboxylate powder. In some embodiments, the polycarboxylate powder is a third-generation high-range water-reducing and superplasticizer powder additive. In some embodiments, the specially formulated polycarboxylate powder as a superplasticizer allows significant water reduction at a relatively low dosage, which further enables good particle dispersion. In some embodiments, the superplasticizer is used in either dry form or in the form of a solution. In some embodiments, a dry form of superplasticizer is preferable.

A person of ordinary skill in the art will understand that a superplasticizer refers to a chemical admixture which is used where a well-dispersed particle suspension is required. The addition of such a superplasticizer allows for the reduction of water content and an increase in the flowability, while not affecting the workability of the underlayment material composition mix. Further, the addition of the superplasticizer improves the strength and durability characteristics of the underlayment material composition.

A retarder comprising modified amino acid is used in some embodiments of the present underlayment material composition. In some embodiments, a recommended weight of the retarder is between 0.1-0.01% of the underlayment material composition. In an example, the quantity of the retarder is approximately 50 grams by volume. In some embodiments, retarders, such as poly condensed amino acid and calcium (Ca) salt, are used in the underlayment material composition. Such retarders help to slow down the hydration process of the underlayment material composition. Further, the retarders provide excellent performance on increasing the setting time of the underlayment material composition. The amounts of the retarders used depend on the type of retarder and are able to easily be determined by a person skilled in the art in accordance with the concrete requirements. A person of ordinary skill in the art will understand that other scenarios are also possible for the same. In some embodiments, the addition of a retarder is able to prolong the setting time. In some embodiments, the initial setting time is customizable by adjusting the retarder dosage.

Underlayment material compositions in accordance with some embodiments exhibit various properties, for example, improved fire resistance, superior strength, self-leveling, quick setting, no curing, compatibility with a wide range of floor coverings, and other like properties. In some embodiments, the underlayment material composition is able to withstand heavy traffic without powdering, chipping, or cracking. In some embodiments, the underlayment material compositions exhibit various technical properties, for example, the thermal resistance (R) @25 mm thickness being approximately R 0.8, specific heat being at least 229 Btu (lb.0 F) at 85° F., dry density being at least 115 lbs/ft³, and compressive strength being more than 3500 PSI.

Underlayment material compositions in accordance with some embodiments have many applications. For example, underlayment material compositions are best suited for commercial, residential, multifamily, radiant heating, and renovation projects. In another example, underlayment material compositions are compatible with any type of floor covering, such as vinyl composition tile, ceramic tile, wood laminate, hardwood, granite, and marble, to name only a few. In yet another example, underlayment material compositions are applied over any type of subfloor, such as veneer and non-veneer wood floor, concrete subfloor, and the like.

Further, the present underlayment material compositions are able to be made available in a prepackaged form, and water is added in an amount that is able to sufficiently produce a mixture with a predetermined range of flowable consistency. In some embodiments, one package of the underlayment material composition weighs around 50 pounds (lbs). Typically, the shelf life of the underlayment material composition is about 6 months from the date of packaging if stored properly, such as, stored under shed at an elevated place on the ground, away from moisture, and below a temperature of 35° C. In some embodiments, the grain size of the compositions ranges from 0-1 mm. A person of ordinary skill in the art will understand that other configurations and scenarios are also possible for the compositions.

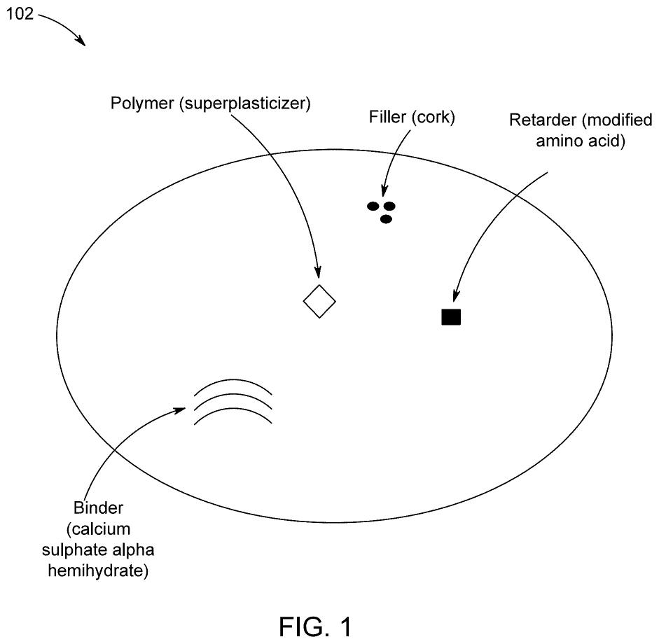

FIG. 1 illustrates ingredients 102, collated in the form of a group, makes up an exemplary underlayment material composition, in accordance with some embodiments of the present disclosure. In some embodiments, the ingredients 102 are able to include, but are not limited to, CSαH, cork, superplasticizer(s), and retarder(s). Thus, in some embodiments, the group of the ingredients 102 is able to be used to manufacture the exemplary underlayment material composition. Further, water is added to the ingredients 102 of the underlayment material composition.

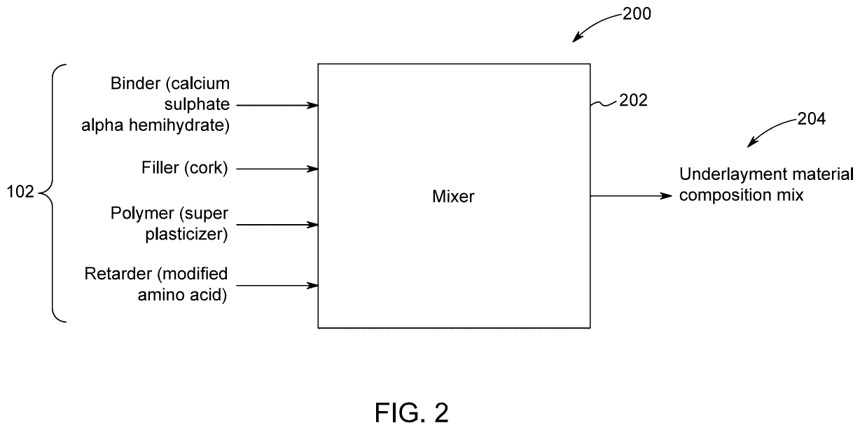

FIG. 2 illustrates an arrangement 200 for manufacturing underlayment material compositions, in accordance with some embodiments of the present disclosure.

The arrangement 200 includes a mixer 202 that receives as input ingredients 102 and produces an underlayment material composition mix 204. The ingredients 102 include a binder, a filler, superplasticizer(s), and retarder(s). In some embodiments, the binder includes CSαH, the filler includes cork, the superplasticizer(s) includes specially formulated polycarboxylate powder, and the retarder(s) includes poly condensed amino acid and calcium (Ca) salt. In some embodiments, all the ingredients 102 are added in the mixer 202 with clean water in appropriate quantities according to the desired underlayment material composition. The table below (Table 1) indicates the appropriate quantities of the components of the underlayment material composition, in accordance with some embodiments. It should be noted that mentioned quantities of ingredients by volume is indicative and are able to be varied due to the intrinsic chemical properties of the materials. Without deviating from the scope of the disclosure, the proportions are able to be adjusted with rapid technological advancements in the materials industry. The quantities indicated in Table 1 are non-limiting. Other ingredients and quantities are contemplated.

TABLE 1

| Component | Quantity |
|---|---|
| Calcium sulfate | Between 49-51% of the underlayment |
| alpha hemihydrate (CSαH) | material composition by volume |
| Cork | Between 48-49% of the underlayment |
| | material composition by volume |
| Superplasticizer | Between 1-2% of the underlayment |
| | material composition by volume |
| Retarder | Between 0.1-0.01% of the underlayment |
| | material composition by volume |

A person of ordinary skill in the art will understand that a mixer, such as the mixer 202, blends and mixes materials, such as the ingredients 102 and water, to produce a resulting mix, such as the underlayment material composition mix 204. In some embodiments, the mixer 202 corresponds to a mechanical mixer that is able to include, but is not limited to, batch mixers such as, drum type mixers and pan type mixers, and continuous mixers, which are able to be used for the present disclosure. A person of ordinary skill in the art will understand that other configurations are also possible for the mixer 202.

Referring to FIG. 2, once the ingredients 102 are mixed with water in the mixer 202 at a normal speed for a predetermined amount of time, a consistent and workable underlayment material composition mix 204 (with a predetermined range of flowable consistency) is obtained that is highly thermal resistant. The consistent and workable underlayment material composition mix 204 is able to be used for various underlayment purposes and are compatible with any type of floor covering, such as, but not limited to, vinyl composition tile, ceramic tile, wood laminate, hardwood, granite, and marble. Further, the consistent and workable underlayment material composition mix 204 is able to be applied over any type of subfloor, such as, but not limited to, veneer and non-veneer wood floor, concrete subfloor, and the like. Thus, the underlayment material composition mix 204 is suitable for any type of commercial, residential, multifamily, radiant heating, and renovation project.

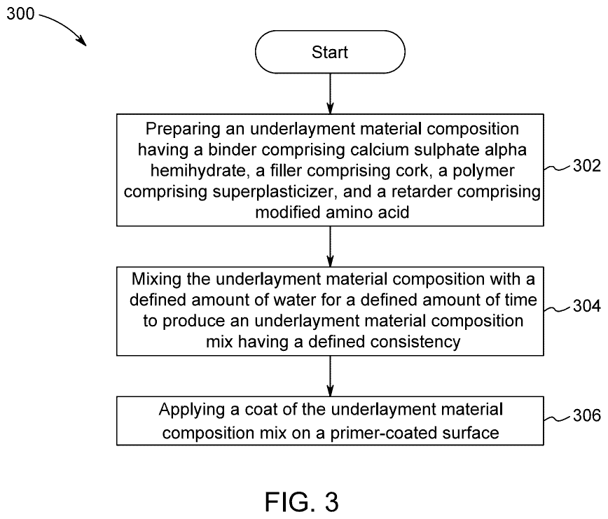

FIG. 3 illustrates a flowchart specifying the steps of a method 300 for preparing and using underlayment material compositions as non-structural materials, in accordance with some embodiments of the present disclosure. The underlayment material composition described herein is equivalent to the underlayment material composition mix 204 of FIG. 2 in the functionality and characteristics, as described above.

Although specific operations are disclosed herein, such operations are examples and are non-limiting. In different embodiments, to name only a few examples, the method 300 includes other steps, the sequence of the steps is modified, some steps are omitted, or any combination of these variations is able to be incorporated. The steps of the method 300 are automated or semi-automated. In various embodiments, one or more of the operations of the method 300 are able to be controlled or managed by software, by firmware, by hardware, or by any combination thereof, but is not limited to such.

In some embodiments, the method 300 includes processes in accordance with the present disclosure which are able to be controlled or managed by a processor(s) and electrical components under the control of a computer or computing device comprising computer-readable media containing non-transitory computer-executable instructions or code that when executed by the processor(s) perform the steps of the method 300. The readable and executable instructions (or code) are able to reside, for example, in data storage such as volatile memory, non-volatile memory, and/or mass data storage, as only some examples. In some embodiments, automation of the method 300 through a computer employs various peripherals such as sensors, robotic arms, etc.

Referring to FIG. 3, at a step 302, underlayment material composition is prepared by mixing various ingredients 202, such as a binder, a filler, superplasticizers, and retarders, in defined amounts. In some embodiments, the binder includes CSαH, the filler includes cork, the retarders include poly condensed amino acid and calcium (Ca) salt, and the superplasticizers include specially formulated polycarboxylate powder. In some embodiments, the mixing ingredients 202 are packed in bags for further usage in non-structural applications.

Next, at a step 304, prepacked bags of the underlayment material composition are mixed with water (for example, in a defined amount) in a mixer (for example, mixer 202 of FIG. 2). In some embodiments, the underlayment material composition is mixed with the defined amount of water in the mixer 202 at a normal speed for a defined amount of time. Accordingly, an underlayment material composition mix 204 is produced having a defined consistency. In some embodiments, the underlayment material composition mix 204 exhibits a thermal resistance value that exceeds a threshold value for a defined thickness value.

In some embodiments, the predetermined amount of time for which the underlayment material composition is blended with water varies based on various factors, such as a batch size, humidity, and temperature. In some embodiments, the predetermined amount of time for which the underlayment material composition is blended is based at least on a type of the mixer used for such purpose. Initially, the underlayment material composition is in powder form, so a slower speed (normal speed) is adequate to blend all ingredients homogeneously. After water is added, the underlayment material composition turns to paste, and the viscosity increases. In some embodiments, the method 300 does not require (excludes) one or more of: steam curing or accelerated curing or water curing.

In some embodiments, the underlayment material composition is able to exhibit various properties such as, but not limited to, a compressive strength of at least 3500 PSI, a dry density of at least 115 lbs/ft³, a thermal resistance of R 0.8 at 25 mm thickness, a specific heat of at least 229 BTU at 85° F., and a Class A1 fire rating or better.

Next, at a step 306, the underlayment material composition mix 204 is discharged to a surface of the subfloor with a pump. Beforehand, it is ensured that the surface is clean, smooth, dry, and free from all loose materials, grease, and oil for the best results. Further, the surface is inspected and in case of any uneven area is observed, such area is repaired, patched, and leveled. Next, a primer is applied to a substrate to obtain good adhesion before pouring the underlayment material composition mix 204 to the subfloor. After pouring, the surface is self-leveled and quickly set, and once ready, a smooth surface is obtained.

Such surfaces of the underlayment material composition mix 204 are able to withstand heavy traffic without powdering, chipping, or cracking. The surfaces of the underlayment material composition mix 204 have superior strength, fire resistance, and fireproof properties. Further, the surfaces of the underlayment material composition mix 204 are compatible with a wide range of floor coverings.

In some embodiments, the underlayment material composition exhibits lower environmental problems and water consumption as compared with conventional underlayment products. For example, the underlayment material composition emits 71% lower CO₂ to the atmosphere (240 gr CO₂ eq/kg) compared with cement-based product (830 gr CO₂ eq/gr). Various other such examples pertaining to other impact categories for the underlayment material composition in comparison with the conventional underlayment products, in accordance with some embodiments, are summarized as below in Table 2. It should be noted that the impact categories indicated in Table 2 are non-limiting. Other impact categories are also able to be contemplated.

TABLE 2

| | | | Underlayment |
|---|---|---|---|
| | | Conventional | Material |
| | | Underlayment | Composition |
| Impact category | Units | Products | Mix |
| Global warming | kg CO₂ eq | 0.83 | 0.24 |
| Stratospheric ozone depletion | kg CFC11 eq | 0.00000009 | 0.00000006 |
| Ionizing radiation | kBq Co-60 eq | 0.01 | 0.004 |
| Ozone formation, Human Health | kg NOx eq | 0.001 | 0.0003 |
| Fine particulate matter formation | kg PM2.5 eq | 0.0004 | 0.0001 |
| Ozone formation, Terrestrial ecosystems | kg NOx eq | 0.001 | 0.0003 |
| Terrestrial acidification | kg SO₂ eq | 0.001 | 0.0003 |
| Freshwater eutrophication | kg P eq | 0.00003 | 0.00001 |
| Terrestrial ecotoxicity | kg 1,4-DCB | 0.47 | 0.14 |
| Freshwater ecotoxicity | kg 1,4-DCB | 0.01 | 0.001 |
| Fossil resource scarcity | kg oil eq | 0.08 | 0.07 |
| Water consumption | m³ | 0.002 | 0.001 |

Embodiments of the underlayment material composition and the methods of making and using them provide an environmentally friendly non-structural product. Mixes of underlayment material compositions in accordance with some embodiments do not contain cement or any cementitious binder, and thus, are green materials. Conventional cement-based mixture compositions undergo a curing process for strength development and durability. However, underlayment material compositions, in accordance with some embodiments, do not require any specialized curing, such as steam curing, accelerated curing, and water curing. Only air curing is performed. Furthermore, a conventional underlayment tends to shrink and crack. However, the proposed underlayment material composition is able to withstand heavy traffic without powdering, chipping, or cracking. To add to the above, the proposed underlayment material composition has superior strength, fire resistance, and fireproof properties. Besides, the proposed underlayment material composition is self-levelling, has a quick setting, and is compatible with a wide range of floor coverings. The proposed underlayment material composition has a highly flowable workability which provides the underlayment material with self-levelling property. The proposed underlayment material composition is not a part of the structural element and does not contribute to the structural integrity of a building, therefore is able to be applied on the subfloor as a cushion.

In some embodiments, the proposed underlayment material composition is a non-structural self-leveling gypsum-cork composite that is typically applied over the veneer and non-veneer wood subfloor panels and structural concrete or precast slab to create a smooth surface. The proposed underlayment material composition sets more quickly than normal concrete and requires minimal surface preparation. The proposed underlayment material composition has the same compressive strength as normal concrete, and at the same time, has 71% lower global warming impact, than a conventional underlayment. Also, the damages of the proposed underlayment material composition to human health and natural resources are 73% and 23% respectively lower than the conventional types.

In some embodiments, a system (in an example, a computer) for performing the steps of method 300 is automated. In some embodiments, the computer is able to comprise a memory storing computer-executable instructions that when executed by a processor(s) perform the steps of method 300.

The terms “comprising,” “including,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention. The term “connecting” includes connecting, either directly or indirectly, and “coupling,” including through intermediate elements.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the practice of the disclosure as broadly disclosed herein without resort to undue experimentation. All art-known functional equivalents of methods, devices, device elements, materials, procedures, and techniques described herein are intended to be encompassed by the disclosure. Whenever a range is disclosed, all subranges and individual values are intended to be encompassed. This presently claimed invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the disclosure has been described with respect to a limited number of embodiments, those skilled in the art, having benefit of this disclosure, will appreciate that other embodiments can be devised which do not depart from the spirit and scope of the disclosure as disclosed herein.

We claim:

1. An underlayment material composition, comprising:
a binder comprising calcium sulphate alpha hemihydrate;
a filler comprising cork;
a polymer comprising superplasticizer; and
a retarder comprising modified amino acid.

2. The underlayment material composition of claim 1, wherein a defined amount of water is added to the underlayment material composition such that a homogeneous mixture is formed with a consistency within a predetermined range.

3. The underlayment material composition of claim 1, wherein the underlayment material composition forms a cement-free composite material.

4. The underlayment material composition of claim 1, wherein the underlayment material composition forms a non-structural self-levelling composite material.

5. The underlayment material composition of claim 1, wherein the underlayment material composition forms a curing-free composite material.

6. The underlayment material composition of claim 1, wherein a coat of the underlayment material composition is applied on different types of subfloors.

7. The underlayment material composition of claim 1, wherein a coat of the underlayment material composition is compatible with different types of floor coverings.

8. The underlayment material composition of claim 1, wherein:
a quantity of the calcium sulphate alpha hemihydrate is between 49-51% of the underlayment material composition by volume;
a quantity of the cork is between 48-49% of the underlayment material composition by volume;
a quantity of the superplasticizer is between 1-2% of the underlayment material composition by volume; and
a quantity of the modified amino acid is between 0.1-0.01% of the underlayment material composition by volume.

9. The underlayment material composition of claim 1, wherein properties of the underlayment material composition comprise one or more of:
a compressive strength of at least 3500 PSI;
a dry density of 115 lbs/ft³;
a thermal resistance of R 0.8 at 25 mm thickness; and
a specific heat of 229 BTU at 85° F.

10. The underlayment material composition of claim 1, wherein the underlayment material exhibits a thermal resistance value that exceeds a threshold value for a defined thickness value.

11. A method of using an underlayment material composition, the method comprising:
preparing the underlayment material composition having:
a binder comprising calcium sulphate alpha hemihydrate;
a filler comprising cork;
a polymer comprising superplasticizer; and
a retarder comprising modified amino acid;
mixing the underlayment material composition with a defined amount of water for a defined amount of time to produce an underlayment material composition mix having a defined consistency; and
applying a coat of the underlayment material composition mix on a primer-coated surface.

12. The method of claim 11, wherein the defined consistency corresponds to a homogeneous mixture of flowable workability.

13. The method of claim 11, wherein the coat of the underlayment material composition mix is applied on different types of subfloors.

14. The method of claim 11, wherein the coat of the underlayment material composition mix is compatible with different types of floor coverings.

15. The method of claim 11, wherein the underlayment material composition mix exhibits a thermal resistance value that exceeds a threshold value for a defined thickness value.

16. A method of preparing an underlayment material, the method comprising:
preparing an underlayment material composition having:
a binder comprising calcium sulphate alpha hemihydrate;
a filler comprising cork;
a polymer comprising superplasticizer; and
a retarder comprising modified amino acid; and
mixing the underlayment material composition with a defined amount of water for a defined amount of time to produce an underlayment material composition mix having a defined consistency.

17. The method of claim 16, wherein:
a quantity of the calcium sulphate alpha hemihydrate is between 49-51% of the underlayment material composition by volume;
a quantity of the cork is between 48-49% of the underlayment material composition by volume;
a quantity of the superplasticizer is between 1-2% of the underlayment material composition by volume; and
a quantity of the modified amino acid is between 0.1-0.01% of the underlayment material composition by volume.

18. The method of claim 16, wherein the underlayment material composition mix exhibits a thermal resistance value that exceeds a threshold value for a defined thickness value.
